(19) United States
(12) Patent Application Publication
(10) Pub. No.: US 2005/0285924 A1
(43) Pub. Date: Dec. 29, 2005

(54) Thermal print head having memory for storing resistance value of heater and image forming apparatus including the thermal print head

(75) Inventor: Kyeong-taeg Yang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/216,029

(22) Filed: Sep. 1, 2005

(30) Foreign Application Priority Data
May 20, 2004 (KR) 10-2004-0095532

(51) Int. Cl. B41J 2/315

(52) U.S. Cl. 347/171

(57) ABSTRACT

Provided is a thermal print head having a memory for storing resistance values of heaters to compensate for an energy drift of the thermal print head. The thermal print head includes a plurality of heaters for applying heat to a medium. A heater driving unit drives the heaters according to received data. A memory stores resistance values of the heaters. Accordingly, the thermal print head having the memory which stores resistance values of heaters compensates for an energy drift of the thermal print head by using the resistance values of the heaters stored in the memory without individually measuring the resistance values, and therefore can achieve uniform print quality

### BACKGROUND OF THE INVENTION

This application claims the benefit under 35 U.S.C. §119(a) of Korean Patent Application No. 10-2004-0095532, filed on Nov. 20, 2004, in the Korean Intellectual Property Office, the entire disclosure of which is hereby incorporated by reference.

1. Field of the Invention

The present invention relates to a thermal print head for printing an image by heating a medium. More particularly, the present invention relates to a thermal print head having a memory which stores resistance values of heaters to compensate for an energy drift of the thermal print head and an image forming apparatus having the thermal print head.

2. Description of the Related Art

Thermal transfer printing devices, which are used to obtain a high quality printed image, form an image by heating an ink ribbon in contact with a medium with a thermal print head and transferring an ink to the medium, or by applying heat to a medium on which an ink layer is formed to reveal a predetermined color in response to heat.

The thermal print head includes a plurality of heaters having a predetermined resistance R. To print an image, the heaters apply heat to the medium, the heat being generated due to a predetermined voltage VHD applied to the heaters. The energy E of the heaters due to the applied voltage VHD is calculated as in Equation (1). An optical density of the image printed by heating the medium by the heaters is directly proportional to the energy E.

$$E = \frac{{VHD}^{2}}{R} \times t \qquad ( 1 )$$

In Equation (1), ‘t’ denotes a heating time for which the heater applies heat to the medium. According to Equation (1), an energy drift is generated due to an applied voltage error of the heater or a resistance error of the heater, and therefore, it is difficult to obtain an image with uniform quality.

Accordingly, there is a need to compensate for the energy drift of the thermal print head. To this end, resistance values of the heaters have to be accurately measured. However, once the heaters are embedded in the thermal print head, it is difficult to measure their resistance values.

### SUMMARY OF THE INVENTION

The present invention provides a thermal print head having a memory which stores resistance values of heaters to compensate for an energy drift of the thermal print head and an image forming apparatus using the thermal print head.

According to an aspect of the present invention, there is provided a thermal print head for printing an image by applying heat to a medium, the thermal print head comprising a plurality of heaters for applying heat to a medium; a heater driving unit for driving the heaters according to received data; and a memory for storing resistance values of the heaters.

The memory may be a non-volatile random access memory, and the memory and the heater driving unit preferably use an identical clock signal.

According to another aspect of the present invention, there is provided an image forming apparatus having a thermal print head for printing an image by applying heat to a medium. The image forming apparatus comprises a data inputting unit for receiving image data to be printed. A thermal print head includes a plurality of heaters for applying heat to the medium. A heater driving unit receives the image data and drives the heaters according to the image data. A memory stores resistance values of the heaters according to the image data. A controlling unit compensates for energy drifts of the heaters using the resistance values of the heaters stored in the memory.

According to still another aspect of the present invention, there is provided an image forming apparatus having a thermal print head for printing an image by applying heat to a medium The image forming apparatus comprises a data inputting unit for receiving image data to be printed. A thermal print head includes a plurality of heaters for applying heat to the medium, and a heater driving unit for receiving the image data and driving the heaters according to the image data. A memory stores resistance values of the heaters according to the image data. A controlling unit compensates for energy drifts of the heaters using the resistance values of the heaters stored in the memory.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a structure of a thermal print head having a memory, according to an embodiment of the present invention;

FIG. 2 is a timing diagram illustrating signals to drive the thermal print head of FIG. 1; and

FIG. 3 is a block diagram of a structure of an image forming apparatus using a thermal print head having a memory, according to an embodiment of the present invention.

Throughout the drawings, like reference numbers should be understood to refer to like features, elements and structures.

### DETAILED DESCRIPTION OF EXEMPLARY EMBODIMENTS

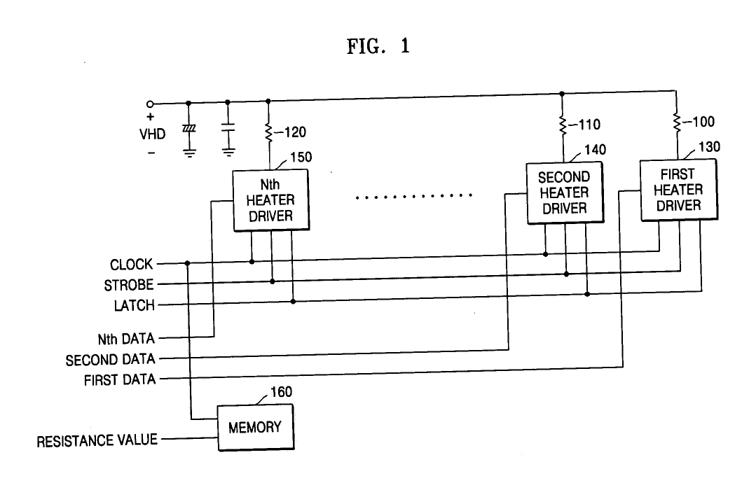

FIG. 1 is a block diagram of a structure of a thermal print head having a memory, according to an embodiment of the present invention. Referring to FIG. 1, the thermal print head includes a plurality of heaters 100, 110 and 120, heater drivers 130, 140, and 150, and a memory 160.

The plurality of heaters 100, 110 and 120 apply heat to a medium and are driven by the heater drivers 130, 140 and 150, each of which respectively corresponds to the heaters 100, 110 and 120. For example, a 3-inch 300dpi thermal print head includes 900 heaters, and the heaters are turned on and off by 900 heater drivers, each of which respectively corresponds to one of the heaters and applies heat, which is generated due to an applied voltage VHD, to a medium.

When the thermal print head receives data to print Cyan (C), Magenta (M), and Yellow (Y) colors, each data value is typically between 0 and 255, and the thermal print head has to apply heat to the medium between 0 and 255 times to print one of the C, M, and Y colors. Therefore, a 256 grayscale value is required for the thermal print head to represent one of the C, M, and Y colors.

The memory 160 stores resistance values of the respective heaters 100, 110, and 120. Preferably, when the thermal print head is manufactured, the resistance values are measured in advance and stored in the memory 160 before the heaters 100, 110 and 120 are embedded in the thermal print head. The memory 160 may be a non-volatile random access memory (NVRAM) such that the resistance values stored therein are not erased even when power is not supplied to the thermal print head.

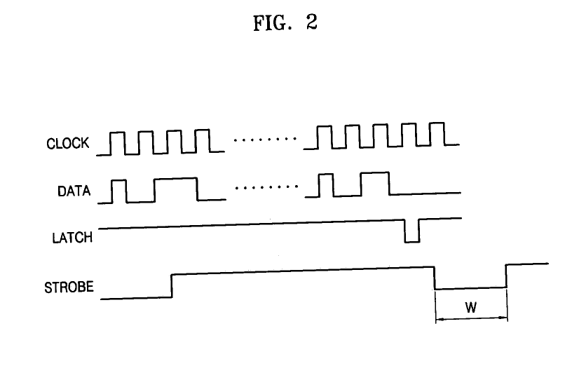

FIG. 2 is a timing diagram illustrating signals input for one grayscale value to drive the thermal print head of FIG. 1. The operation of the thermal print head will now be described with reference to FIG. 2. Image data including information of whether the heaters 100, 110 and 120 of the thermal print head are heated, that is, are turned on or off, is synchronized with a clock and input in series to a shift register in the heater drivers 130, 140 or 150. When the image data of all heaters are input, the input data is temporarily stored in flip-flops of the heater drivers 130, 140 and 150 corresponding to the respective heaters 100, 110, and 120 according to a latch signal. When the value of the data stored in the flip-flop corresponding to each heater 100, 110, and 120 is high, the heaters 100, 110 and 120 apply heat to the medium for a period of time W when a strobe signal is low.

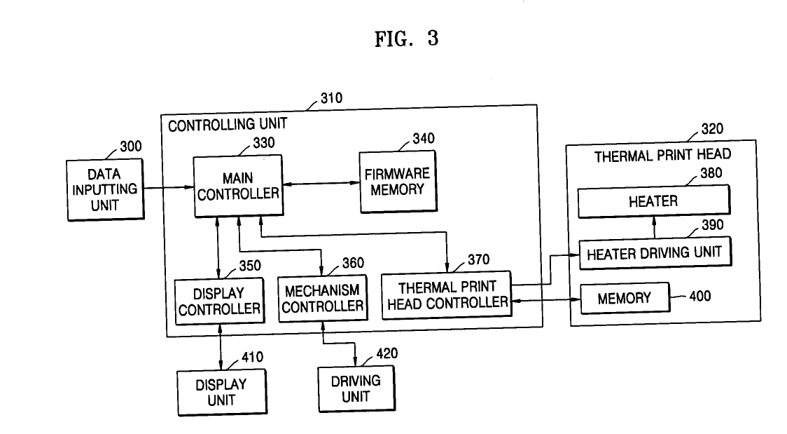

FIG. 3 is a block diagram of a structure of an image forming apparatus using a thermal print head having a memory, according to an embodiment of the present invention. Referring to FIG. 3, the image forming apparatus includes a data inputting unit 300, a controlling unit 310, a thermal print head 320, a display unit 410, and a driving unit 420.

The data inputting unit 300 receives image data to be printed from an external device such as a personal computer (PCs), digital camera, or personal digital assistant (PDA).

The controlling unit 310 generates signals for controlling operations of the thermal print head 320, the display unit 410, and the driving unit 420 of the image forming apparatus, and preferably includes a main controller 330, a firmware memory 340, a display controller 350, a mechanism controller 360, and a thermal print head controller 370. The thermal print head 320 preferably includes heater 380, a heater driving unit 390, and a memory 400 which stores a resistance value of the heater 380.

The main controller 330 receives image data to be printed from the data inputting unit 300 and generally controls the operation of the image forming apparatus using a firmware program stored in the firmware memory 340. The firmware program is permanently installed in a computer device and is preferably stored in a flash memory.

The thermal print head controller 370 generates a driving signal for driving the heater 380 by compensating for an energy drift of the heater using the control signal input from the main controller 330 and the resistance value of the heater 380 stored in the memory 400.

To compensate for an energy drift using the resistance value of the heater 380, the voltage VHD applied to the heater is measured. As such the heating time ‘t’ of the heater 380 for equalizing the energy E applied to the heater 380 can be obtained by substituting the applied voltage VHD and the resistance value of the heater 380 into Equation 1. As shown in FIG. 2, since the width W of the strobe signal is a heating time for which a heater applies heat to a medium, the energy drift can be adjusted by controlling each width W of the strobe signals for driving respective heaters.

The heater driving unit 390 receives a driving signal from the thermal print head controller 370, and the heater 380 that applies heat to a medium is driven by a plurality of heater drivers included in the heater driving unit 390.

The display controller 350 generates a signal for controlling the operation of the display unit 410, and the display unit 410 can display the resistance values of the heaters 380 stored in the memory 400 on a screen.

The mechanism controller 360 generates a signal for controlling the operation of the driving unit 420, and the driving unit 420 drives the mechanical operations, such as transferring a medium on which an image is printed, of the image forming apparatus.

The memory 400 which stores the resistance value of the heater 380 may be placed at the outside of the thermal print head 320.

As described above, according to an embodiment of the present invention, a thermal print head having a memory which stores resistance values of heaters compensates for an energy drift of the thermal print head by using the resistance values of the heaters stored in the memory without individually measuring the resistance values, and therefore can advantageously achieve uniform print quality.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A thermal print head for printing an image by applying heat to a medium, the thermal print head comprising:
a plurality of heaters for applying heat to a medium;
a memory for storing resistance values of the heaters; and
a heater driving unit for driving the heaters according to received data and said resistance values

2. The thermal print head of claim 1, wherein the memory is a non-volatile random access memory.

3. The thermal print head of claim 1, wherein the memory and the heater driving unit use an identical clock signal.

4. An image forming apparatus having a thermal print head for printing an image by applying heat to a medium, the image forming apparatus comprising:
a data inputting unit for receiving image data to be printed;
a thermal print head including a plurality of heaters for applying heat to the medium, a heater driving unit for receiving the image data and driving the heaters according to the image data, and a memory which stores resistance values of the heaters according to the image data; and
a controlling unit for compensating for energy drifts of the heaters using the resistance values of the heaters stored in the memory.

5. The image forming apparatus of claim 4, wherein the memory is a non-volatile random access memory.

6. The image forming apparatus of claim 4, wherein the controlling unit controls driving signals for driving the heaters using the resistance value of the heaters.

7. The image forming apparatus of claim 4, further comprising:
a display unit for displaying the resistance values of the heaters stored in the memory.

8. An image forming apparatus having a thermal print head for printing an image by applying heat to a medium, the image forming apparatus comprising:
a data inputting unit for receiving image data to be printed;
a thermal print head including a plurality of heaters for applying heat to the medium, and a heater driving unit for receiving the image data and driving the heaters according to the image data;
a memory for storing resistance values of the heaters according to the image data; and
a controlling unit for compensating for energy drifts of the heaters using the resistance values of the heaters stored in the memory.

9. A method of printing an image using a thermal print head comprising the steps of:
storing resistance values of a plurality of heaters; and
driving said plurality of heaters based on said stored resistance values.

10. The method of printing of claim 9, wherein said storing step further comprising storing said resistance values in a memory.

11. The method of printing of claim 10, wherein said storing step comprises storing said resistance values in a nonvolatile random access memory.

12. A computer readable medium of instructions for controlling a thermal print head comprising:
a first set of instructions adapted to store resistance values of a plurality of heaters; and
a second set of instructions adapted to drive said plurality of heaters based on said stored resistance values.
